(19) United States
(12) Patent Application Publication
(10) Pub. No.: US 2023/0185822 A1
(43) Pub. Date: Jun. 15, 2023

(54) DISTRIBUTED STORAGE SYSTEM

(71) Applicant: SAMSUNG ELECTRONICS CO., LTD., Suwon-si (KR)

(72) Inventors: Sungmin LEE, Suwon-si (KR); Myoungwon OH, Suwon-si (KR); Sungkyu PARK, Seoul (KR)

(73) Assignee: SAMSUNG ELECTRONICS CO., LTD., Suwon-si (KR)

(21) Appl. No.: 17/949,442

(22) Filed: Sep. 21, 2022

(30) Foreign Application Priority Data
Dec. 10, 2021 (KR) 10-2021-0176199
Apr. 22, 2022 (KR) 10-2022-0049953

(51) Int. Cl. G06F 16/27

(52) U.S. Cl. CPC G06F 16/27

(57) ABSTRACT

A distributed storage system includes a plurality of host servers including a primary compute node and backup compute nodes for processing first data having a first identifier, and a plurality of storage nodes that communicates communicate with the plurality of compute nodes, and includes a plurality of storage volumes. The plurality of storage volumes include a primary storage volume and backup storage volumes for storing the first data. The primary compute node provides a replication request for the first data to a primary storage node providing the primary storage volume, when a write request for the first data is received and the primary storage node stores, based on the replication request, the first data in the primary storage volume, copies the first data to the backup storage volumes, and provides, to the primary compute node, a completion acknowledgement to the replication request.

CROSS-REFERENCE TO RELATED APPLICATION(S)

This application is based on and claims benefit of priority to Korean Patent Application No. 10-2021-0176199 filed on Dec. 10, 2021 and Korean Patent Application No. 10-2022-0049953 filed on Apr. 22, 2022 in the Korean Intellectual Property Office, the disclosures of which are incorporated herein by reference in their entirety.

### BACKGROUND

### 1. Field

One or more example embodiments relate to a distributed storage system.

A distributed storage system included in a data center may include a plurality of server nodes, each including a computation unit and a storage unit, and data may be distributed and stored in the server nodes. In order to ensure availability, the storage system may replicate the same data in multiple server nodes. A replication operation may cause a bottleneck in the computation unit, and may make it difficult for the storage unit to exhibit maximal performance.

### 2. Description of Related Art

Recently, research has been conducted to reorganize a server-centric structure of the distributed storage system into a resource-centric structure. In a disaggregated storage system having a resource-oriented structure, compute nodes performing a computation function and storage nodes performing a storage function may be physically separated from each other.

### SUMMARY

Example embodiments provide a distributed storage system capable of improving data input/output performance by efficiently performing a replication operation.

Example embodiments provide a distributed storage system capable of quickly recovering from a fault of a compute node or storage node.

According to an aspect of the disclosure, there is provided a distributed storage system including: a plurality of host servers including a plurality of compute nodes; and a plurality of storage nodes configured to communicate with the plurality of compute nodes via a network, the plurality of storage nodes comprising a plurality of storage volumes, wherein the plurality of compute nodes include a primary compute node and backup compute nodes configured to process first data having a first identifier, the plurality of storage volumes include a primary storage volume and backup storage volumes configured to store the first data, the primary compute node is configured to provide a replication request for the first data to a primary storage node including the primary storage volume, based on a reception of a write request corresponding to the first data, and based on the replication request, the primary storage node is configured to store the first data in the primary storage volume, copy the first data to the backup storage volumes, and provide, to the primary compute node, a completion acknowledgement to the replication request.

According to another aspect of the disclosure, there is provided a distributed storage system including: a plurality of computing domains including a plurality of compute nodes for distributed processing of a plural pieces of data having different identifiers; and a plurality of storage nodes configured to communicate with the plurality of compute nodes according to an interface protocol, the plurality of storage nodes comprising a plurality of storage volumes for distributed storage of the plural pieces of data having different identifiers, wherein a primary compute node among the plurality of compute nodes is configured to: receive a write request for a first piece of data, among the plural pieces of data; select a primary storage volume and one or more backup storage volumes from different storage nodes among the plurality of storage nodes by performing a hash operation using an identifier of the first piece of data as an input; and provide a replication request for the first piece of data to a primary storage node including the primary storage volume.

According to an aspect of the disclosure, there is provided a distributed storage system including: a plurality of host servers including a plurality of compute nodes for distributed processing of a plural pieces of data having different identifiers; and a plurality of storage nodes configured to communicate with the plurality of compute nodes according to an interface protocol, the plurality of storage nodes comprising a plurality of storage volumes for distributed storage of data pieces having different identifiers, wherein a primary compute node, among the plurality of compute nodes, is configured to: receive an access request for a first piece of data, among the plural pieces of data, from a client; determine, based on an identifier of the first piece of data, a primary storage volume and backup storage volumes storing the first piece of data; allocate one of the backup storage volumes based on an occurrence of a fault being detected in the primary storage volume; and process the access request by accessing the allocated storage volume.

According to an aspect of the disclosure, there is provided a server including: a first compute node; a memory storing one or more instructions; and a processor configured to execute the one or more instructions to: receive a request corresponding to first data having a first identifier; identify the first compute node as a primary compute node, and a second compute node as a backup compute node based on the first identifier; based on a determination that the first compute node is available, instruct the first compute node to process the request corresponding to the first data, the first compute node configured to determine a first storage volume as a primary storage, and a second storage volume as backup storage based on the first identifier; and based on a determination of a fault with the first compute node, instruct the second compute node to process the request corresponding to first data.

Aspects of the present inventive concept are not limited to those mentioned above, and other aspects not mentioned above will be clearly understood by those skilled in the art from the following description.

### BRIEF DESCRIPTION OF DRAWINGS

The above and other aspects, features, and advantages of the present inventive concept will be more clearly understood from the following detailed description, taken in conjunction with the accompanying drawings, in which:

FIG. 1 is a block diagram illustrating a storage system according to an example

embodiment;

FIG. 2 is a block diagram illustrating a software stack of a storage system according to an example embodiment;

FIG. 3 is a diagram illustrating a replication operation of a storage system according to an example embodiment;

FIG. 4 is a block diagram specifically illustrating a storage system according to an example embodiment;

FIGS. 5A and 5B are diagrams illustrating a hierarchical structure of compute nodes and a hierarchical structure of storage nodes, respectively;

FIGS. 6A and 6B are diagrams illustrating a method of mapping compute nodes and storage nodes;

FIG. 7 is a diagram illustrating a data input/output operation of a storage system according to an example embodiment;

FIGS. 8 and 9 are diagrams illustrating a fault recovery operation of a storage system according to an example embodiment; and

FIG. 10 is a diagram illustrating a data center to which a storage system is applied according to an example embodiment.

### DETAILED DESCRIPTION

Hereinafter, example embodiments are described with reference to the accompanying drawings.

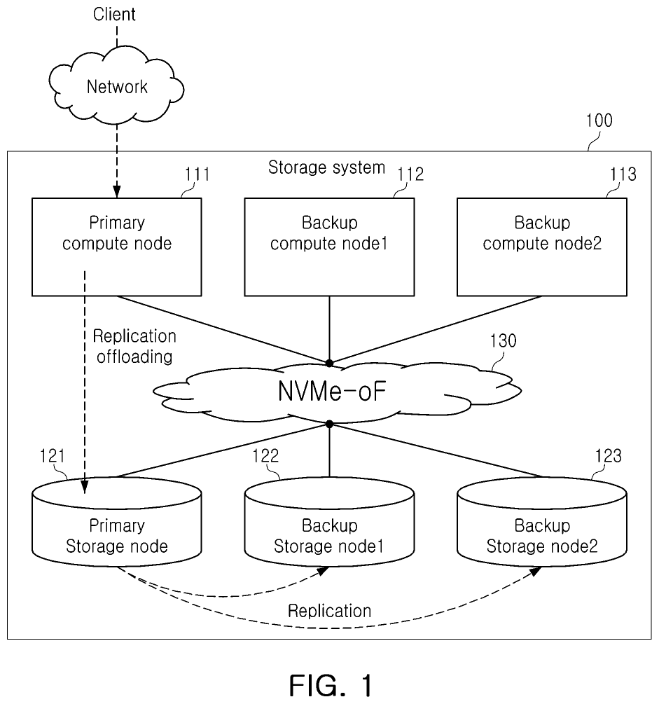

FIG. 1 is a block diagram illustrating a storage system according to an example embodiment.

Referring to FIG. 1, a storage system 100 may include a plurality of compute nodes 111, 112 and 113 and a plurality of storage nodes 121, 122 and 123. The plurality of compute nodes 111, 112 and 113 may include computational resources such as a Central Processing Unit (CPU), processors, arithmetic logic unit (ALU) or other processing circuits, and the like, and the plurality of storage nodes 121, 122 and 123 may include storage resources such as a solid state drive (SSD), a hard disk drive (HDD), and the like.

The plurality of compute nodes 111, 112 and 113 and the plurality of storage nodes 121, 122 and 123 may be physically separated from each other, and may communicate via a network 130. That is, the storage system 100 in FIG. 1 may be a disaggregated distributed storage system in which compute nodes and storage nodes are separated from each other. The plurality of compute nodes 111, 112 and 113 and the plurality of storage nodes 121, 122 and 123 may communicate via the network 130 while complying with an interface protocol such as NVMe over Fabrics (NVMe-oF).

According to an example embodiment, the storage system 100 may be an object storage storing data in units called objects. Each object may have a unique identifier. The storage system 100 may search for data using the identifier, regardless of a storage node in which the data is stored. For example, when an access request for data is received from a client, the storage system 100 may perform a hash operation using, as an input, an identifier of an object to which the data belongs, and may search for a storage node in which the data is stored according to a result of the hash operation. However, the storage system 100 is not limited to an object storage, and as such, according to other example embodiments, the storage system 100 may be a block storage, file storage or other types of storage.

The disaggregated distributed storage system may not only distribute and store data in the storage nodes 121, 122 and 123 according to the object identifier but also allow the data to be divided and processed by the compute nodes 111, 112 and 113 according to the object identifier. The disaggregated distributed storage system may flexibly upgrade, replace, or add the storage resources and compute resources by separating the storage nodes 121, 122 and 123 and the compute nodes 111, 112 and 113 from each other.

The storage system 100 may store a replica of data belonging to one object in a predetermined number of storage nodes, so as to ensure availability. In addition, the storage system 100 may allocate a primary compute node for processing the data belonging to the one object, and a predetermined number of backup compute nodes capable of processing the data when a fault occurs in the primary compute node. Here, the availability may refer to a property of continuously enabling normal operation of the storage system 100.

In the example of FIG. 1, a primary compute node 111 and backup compute nodes 112 and 113 may be allocated to process first data having a first identifier. When there is no fault in the primary compute node 111, the primary compute node 111 may process an access request for the first data. When a fault occurs in the primary compute node 111, one of the backup compute nodes 112 and 113 may process the access request for the first data.

In addition, a primary storage node 121 and backup storage nodes 122 and 123 may be allocated to store the first data. When the first data is written to the primary storage node 121, the first data may also be written to the backup storage nodes 122 and 123. Conversely, when the first data is read, only the primary storage node 121 may be accessed. When there is a fault in the primary storage node 121, one of the backup storage nodes 122 and 123 may be accessed to read the first data.

According to the example embodiment illustrated in FIG. 1, a case in which three compute nodes and three storage nodes are allocated with respect to one object identifier is exemplified, but the number of allocated compute nodes and storage nodes is not limited thereto. The number of allocated storage nodes may vary depending on the number of replicas to be stored in the storage system. In addition, the number of compute nodes to be allocated may be the same as the number of storage nodes, but is not necessarily the same.

In order to ensure availability of the storage system 100, the first data stored in the primary storage node 121 may also need to be replicated in the backup storage nodes 122 and 123. When the primary compute node 111 performs both the operation of storing data in the primary storage node 121 and the operation of copying and storing the data in each of the backup storage nodes 122 and 123, required computational complexity of the primary compute node 111 may be increased. When the required computational complexity of the primary compute node 111 is increased, a bottleneck may occur in the primary compute node 111, and performance of the storage nodes 121, 122 and 123 may not be fully exhibited. As a result, a throughput of the storage system 100 may be reduced.

According to an example embodiment, the primary compute node 111 may offload a replication operation of the first data to the primary storage node 121. For example, when a write request for the first data is received from the client, the primary compute node 111 may provide a replication request for the first data to the primary storage node 121. According to an example embodiment, based on the replication request, the primary storage node 121 may store the first data in the primary storage node 121, and copy the first data to the backup storage nodes 122 and 123. For example, in response to the replication request, the primary storage node 121 may store the first data therein, and copy the first data to the backup storage nodes 122 and 123. The storage nodes 121, 122 and 123 may also communication with each other according to the NVMe-oF protocol via the network 130, so as to copy data.

According to an example embodiment, the primary compute node 111 may not be involved in an operation of copying the first data to the backup storage nodes 122 and 123, and may process another request while the first data is copied, thereby preventing the bottleneck of the primary compute node 111, and improving the throughput of the storage system 100.

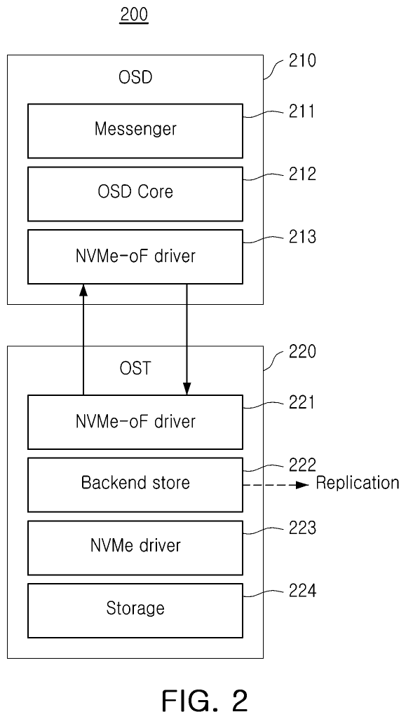

FIG. 2 is a block diagram illustrating a software stack of a storage system according to an example embodiment.

Referring to FIG. 2, a storage system 200 may run an object-based storage daemon (OSD) 210 and an object-based storage target (OST) 220. For example, the OSD 210 may be run in the compute nodes 111, 112, and 113 described with reference to FIG. 1, and the OST 220 may be run in the storage nodes 121, 122, and 123 described with reference to FIG. 1.

The OSD 210 may run a messenger 211, an OSD core 212, and an NVMe-oF driver 213.

According to an example embodiment, the messenger 211 may support interfacing between a client and the storage system 200 via an network. For example, the messenger 211 may receive data and a request from the client, and may provide the data to the client. According to an example embodiment, the messenger 211 may receive data from and a request from the client in an external network, and may provide the data to the client.

The OSD core 212 may control an overall operation of the OSD 210. For example, the OSD core 212 may determine, according to an object identifier of data, compute nodes for processing the data and storage nodes for storing the data. In addition, the OSD core 212 may perform access to a primary storage node, and may perform fault recovery when a fault occurs in the primary storage node.

The NVMe-oF driver 213 may transmit data and a request to the OST 220 according to an NVMe-oF protocol, and may receive data from the OST 220.

The OST 220 may run an NVMe-oF driver 221, a backend store 222, an NVMe driver 223, and a storage 224.

According to an example embodiment, the NVMe-oF driver 221 may receive data in conjunction with a request from the OSD 210, or may provide data to the OSD 210 based the request from the OSD 210. For example, the NVMe-oF driver 221 may receive data in conjunction with a request from the OSD 210, or may provide data to the OSD 210 in response to the request from the OSD 210. In addition, according to an example embodiment, the NVMe-oF driver 221 may perform data input and/or output between the OSTs 220 run in different storage nodes.

The backend store 222 may control an overall operation of the OST 220. According to an example embodiment, the backend store 222 may perform a data replication operation in response to the request from the OSD 210. For example, when a replication request is received, the OST 220 of the primary storage node may store data in the internal storage 224, and copy the data to another storage node.

The NVMe driver 223 may perform interfacing of the backend store 222 and the storage 224 according to the NVMe protocol.

The storage 224 may manage a storage resource included in a storage node. For example, the storage node may include a plurality of storage devices such as an SSD and an HDD. The storage 224 may form a storage space provided by the plurality of storage devices into storage volumes that are logical storage spaces, and may provide the storage space of the storage volumes to the OSD 210.

According to an example embodiment, the OSD 210 and the OST 220 may be simultaneously run in a compute node and a storage node, respectively. The replication operation may be offloaded to the OST 220, thereby reducing a bottleneck occurring in the OSD 210, and improving a throughput of the storage system 200.

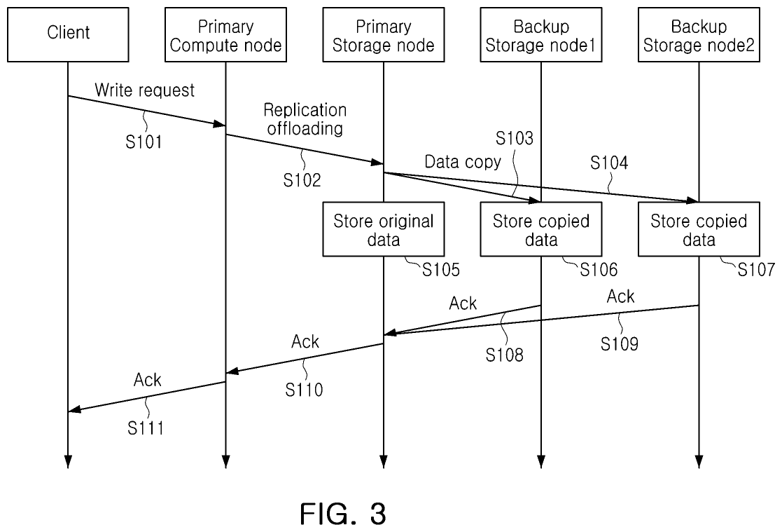

FIG. 3 is a diagram illustrating a replication operation of a storage system according to an example embodiment.

In operation S101, a client may provide a write request to a primary compute node. The client may perform a hash operation based on an identifier of data to be write-requested, thereby determining a primary compute node to process the data among a plurality of compute nodes included in a storage system, and providing the write request to the primary compute node.

In operation S102, the primary compute node may offload, based on the write request, a replication operation to a primary storage node. For example, the primary compute node may offload, based on the write request, a replication operation to a primary storage node. The primary compute node may perform the hash operation based on the identifier of the data, thereby determining a primary storage node and backup storage nodes in which the data is to be stored. In addition, the primary compute node may provide a replication request to the primary storage node.

In operations S103 and S104, the primary storage node may copy the data to first and second backup storage nodes based on the replication request. For example, in response to the replication request, in operation S103, the primary storage node may copy the data to a first backup storage nodel, and in operation S104, the primary storage node may copy the data to a second backup storage node2.

In operation S105, the primary storage node may store the data received from the primary compute node. In operations S106 and S107, the first and second backup storage nodes may store the data copied by the primary storage node.

In operations S108 and S109, when storage of the copied data is completed, the first and second backup storage nodes may provide an acknowledgment signal to the primary storage node.

In operation S110, when storage of the data received from the primary compute node is completed and acknowledgement signals are received from the first and second backup storage nodes, the primary storage node may provide, to the primary compute node, an acknowledgment signal for the replication request.

In operation S111, when the acknowledgment signal is received from the primary storage node, the primary compute node may provide, to the client, an acknowledgment signal for the write request.

According to an example embodiment, once a replication request is provided to a primary storage node, a primary compute node may not be involved in a replication operation until an acknowledgment signal is received from the primary storage node. The primary compute node may process another request from a client while the primary storage node performs the replication operation. That is, a bottleneck in a compute node may be alleviated, and a throughput of a storage system may be improved.

According to another example embodiment, the order of operations is not limited to the order described according to the example embodiment with reference to FIG. 3. For example, operations S103 to S108 may be performed in any order. For example, according to an example embodiment, the data copy operations S103 and S104 may be performed after the original data is stored in the primary storage node in operation S105.

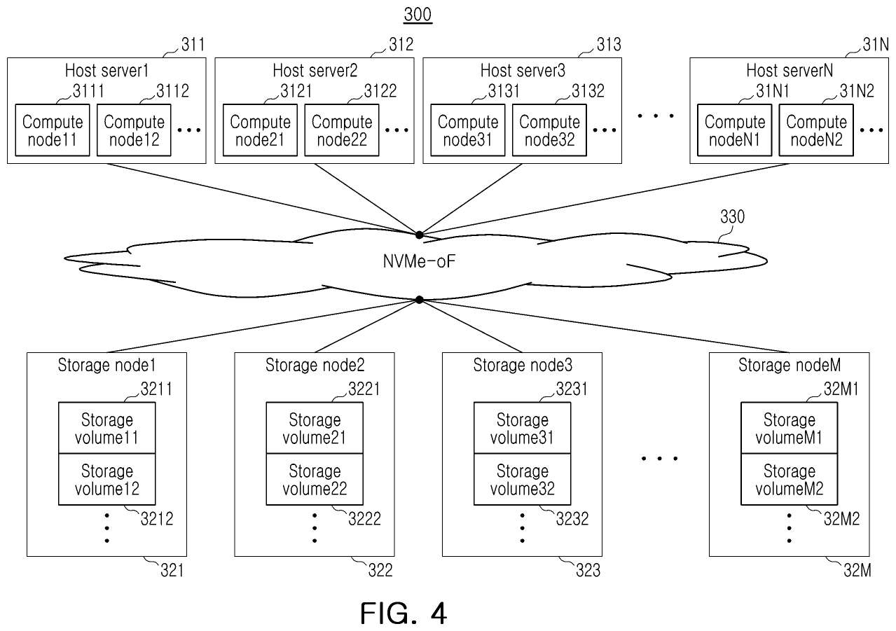

In the example of FIG. 1, three compute nodes 111, 112 and 113 and three storage nodes 121, 122 and 123 are illustrated, but the number of compute nodes and storage nodes that may be included in the storage system is not limited thereto. In addition, the storage system may include a plurality of compute nodes and storage nodes. The storage system may select a predetermined number of compute nodes and storage nodes from among a plurality of compute nodes and storage nodes so as to store data having an identifier. Hereinafter, a method in which the storage system selects the compute nodes and storage nodes according to an example embodiment is described in detail with reference to FIGS. 4 to 6B.

FIG. 4 is a block diagram specifically illustrating a storage system according to an example embodiment.

Referring to FIG. 4, a storage system 300 may include a plurality of host servers 311 to 31N and a plurality of storage nodes 321 to 32M. For example, the plurality of host servers may include a first host server 311, a second host server 312, a third host server 313, . . . , and an Nth host server 31N and the plurality of storage nodes may include a first storage node 321, a second storage node 322, a third storage node 323, . . . , and an Mt^{h} storage node 32M. Here, N and M may be integers that are same or different from each other. The host servers 311 to 31N may provide a service in response to requests from clients, and may include a plurality of compute nodes 3111, 3112, 3121, 3122, 3131, 3132, 31N1 and 31N2. For example, the first host server 311 may include a first compute node 3111 and a second compute note 3112, the second host server 312 may include a third compute node 3121 and a fourth compute note 3122, the third host server 313 may include a fifth compute node 3131 and a sixth compute note 3132, . . . , and an Nt^{h} host server 31N may include a seventh compute node 31N1 and an eighth compute note 31N2. However, the disclosure is not limited thereto, and as such, each of the first host server 311, the second host server 312, the third host server 313, . . . , and the Nth host server 31N may include more than two compute nodes. The host servers 311 to 31N may be physically located in different spaces. For example, the host servers 311 to 31N may be located in different server racks, or may be located in data centers located in different cities or different countries.

The plurality of compute nodes 3111, 3112, 3121, 3122, 3131, 3132, 31N1 and 31N2 may correspond to any of the compute nodes 111, 112 and 113 described with reference to FIG. 1. For example, one primary compute node and two backup compute nodes may be selected from among the plurality of compute nodes 3111, 3112, 3121, 3122, 3131, 3132, 31N1 and 31N2 so as to process first data having a first identifier.

The plurality of storage nodes 321 to 32M may store data used by clients. The plurality of storage nodes 321 to 32M may also be physically located in different spaces. In addition, the plurality of host servers 321 to 32N and the plurality of storage nodes 321 to 32M may also be physically located in different spaces with respect to each other.

The plurality of storage nodes 321 to 32M may correspond to any of the storage nodes 121, 122 and 123 described with reference to FIG. 1. For example, one primary storage node and two backup storage nodes may be selected from among the plurality of storage nodes 321 to 32M so as to store the first data.

The plurality of storage nodes 321 to 32M may provide a plurality of storage volumes 3211, 3212, 3221, 3222, 3231, 3232, 32M1 and 32M2. For example, the first storage node 321 may include a first storage volume 3211 and a second storage volume 3212, the second storage node 322 may include a third storage volume 3221 and a fourth storage volume 322, the fifth storage node 323 may include a fifth storage volume 3231 and a sixth storage volume 3232, . . . , and an Nth storage node 32M may include a seventh storage volume 32M1 and an eighth storage volume 32M2. However, the disclosure is not limited thereto, and as such, each of the first storage volume 321, the second storage volume 322, the third storage volume 323, . . . , and the Mth storage volume 32M may include more than two storage volumes. Logical storage spaces provided by a storage node to a compute node using a storage resource may be referred to as storage volumes.

According to an example embodiment, a plurality of storage volumes for storing the first data may be selected from different storage nodes. For example, storage volumes for storing the first data may be selected from each of the primary storage node and the backup storage nodes. In the primary storage node, a storage volume for storing the first data may be referred to as a primary storage volume. In the backup storage node, a storage volume for storing the first data may be referred to as a backup storage volume.

According to an example embodiment, storage volumes for storing the first data may be selected from different storage nodes, and thus locations in which replicas of the first data are stored may be physically distributed. When replicas of the same data are physically stored in different locations, even if a disaster occurs in a data center and data of one storage node is destroyed, data of another storage node may be likely to be protected, thereby further improving availability of a storage system. Similarly, compute nodes for processing data having an identifier may also be selected from different host servers, thereby improving availability of the storage system.

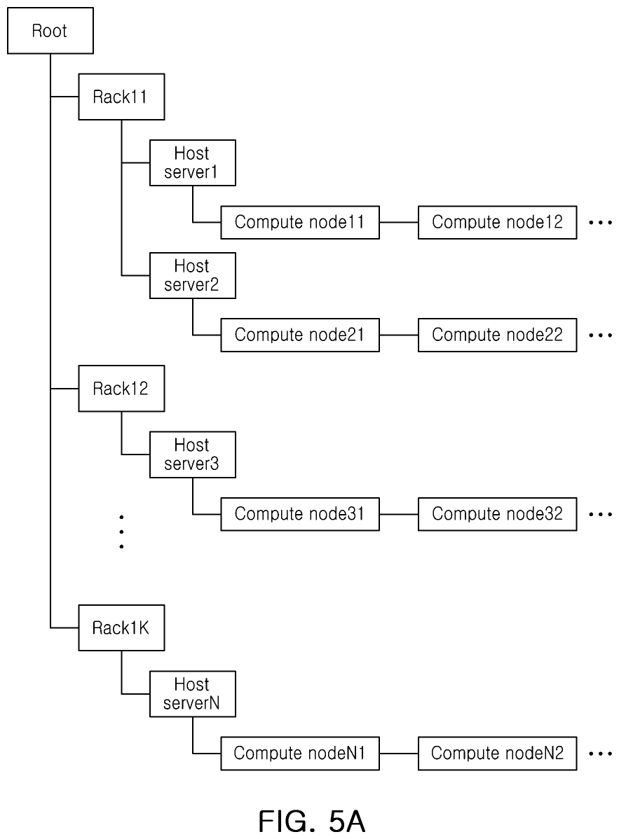

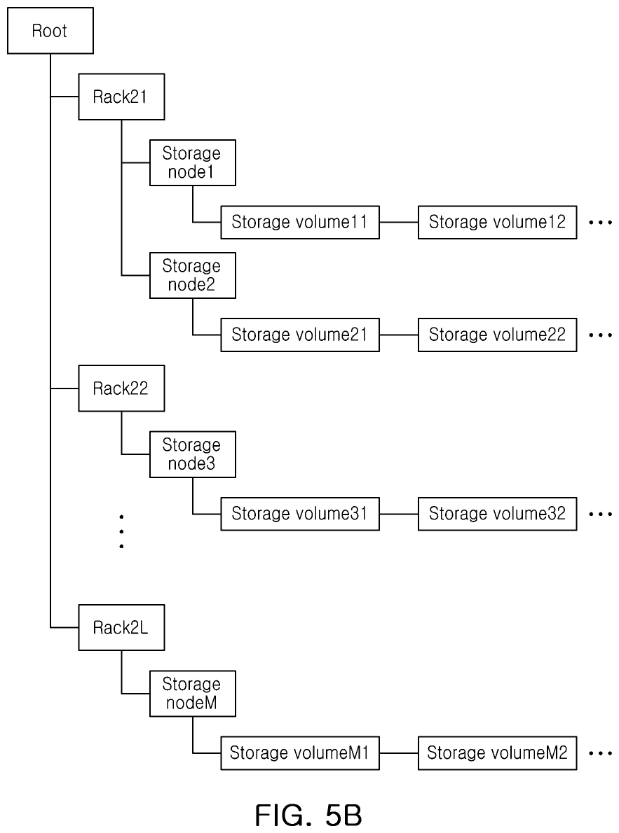

As described with reference to FIGS. 1 and 4, a compute resource and a storage resource of the storage system may be formed independently of each other. FIGS.5A and 5B are diagrams illustrating a hierarchical structure of compute resources and a hierarchical structure of storage resources, respectively.

FIG. 5A illustrates the hierarchical structure of compute resources as a tree structure. In the tree structure of FIG. 5A, a top-level root node may represent a compute resource of an entire storage system.

A storage system may include a plurality of server racks Rack11 to Rack1K. For example, the plurality of server racks may include Rack'', Rack12, , Rack1K. The server racks Rack11 to Rack1K are illustrated in a lower node of the root node. Depending on an implementation, the server racks Rack11 to Rack1K may be physically distributed. For example, the server racks Rack11 to Rack1K may be located in data centers in different regions.

The plurality of server racks Rack11 to Rack1K may include a plurality of host servers. The host servers are illustrated in a lower node of a server rack node. The host servers may correspond to the host servers 311 to 31N described with reference to FIG. 4. The host servers may include a plurality of compute nodes. The plurality of compute nodes may correspond to the compute nodes 3111, 3112, 3121, 3122, 3131, 3132, 31N1 and 31N2 described with reference to FIG. 4.

According to an example embodiment, a primary compute node and backup compute nodes for processing data having an identifier may be selected from different computing domains. A computing domain may refer to an area including one or more compute nodes. For example, the computing domain may correspond to one host server or one server rack. The computing domains may be physically spaced apart from each other. When a plurality of compute nodes that are usable to process the same data are physically spaced apart from each other, availability of a storage system may be improved.

Information on the hierarchical structure of the compute resources illustrated in FIG. 5A may be stored in each of the plurality of compute nodes. The information on the hierarchical structure may be used to determine a primary compute node and backup compute nodes. When a fault occurs in the primary compute node, the information on the hierarchical structure may be used to change one of the backup compute nodes to a primary compute node.

FIG. 5B illustrates the hierarchical structure of storage resources as a tree structure. In the tree structure of FIG. 5B, a top-level root node may represent storage resources of an entire storage system.

In a similar manner to that described in FIG. 5A, the storage system may include a plurality of server racks Rack21 to Rack2L. For example, the plurality of server racks may include Rack21, Rack222, Rack2L. The server racks Rack21 to Rack2L may be physically spaced apart from each other, and may also be physically spaced apart from the server racks Rack11 to Rack1K in FIG. 5A.

The plurality of server racks Rack21 to Rack2L may include a plurality of storage nodes. For example, a plurality of storage devices may be mounted on the plurality of server racks Rack21 to Rack2L. The storage devices may be grouped to form a plurality of storage nodes. The plurality of storage nodes may correspond to the storage nodes 321 to 32M in FIG. 4.

Each of the plurality of storage nodes may provide storage volumes that are a plurality of logical spaces. A plurality of storage volumes may correspond to the storage volumes 3211, 3212, 3221, 3222, 3231, 3232, 32M1 and 32M2 in FIG. 4.

As described with reference to FIG. 4, storage volumes for storing data having an identifier may be selected from different storage nodes. The different storage nodes may include physically different storage devices. Thus, when the storage volumes are selected from the different storage nodes, replicas of the same data may be physically distributed and stored. The storage nodes including the selected storage volumes may include a primary storage node and backup storage nodes.

Information on the hierarchical structure of the storage resources illustrated in FIG. 5B may be stored in each of a plurality of compute nodes. The information on the hierarchical structure may be used to determine a primary storage node and backup storage nodes. When a fault occurs in the primary storage node, the information on the hierarchical structure may be used to change an available storage node among the backup storage nodes to a primary storage node.

Compute nodes for processing data and storage nodes for storing the data may be differently selected according to an identifier of the data. That is, data having different identifiers may be stored in different storage nodes, or in the same storage node.

The compute nodes and the storage nodes according to the identifier of the data may be selected according to a result of a hash operation. In addition, mapping information of the compute nodes and storage nodes selected according to the result of the hash operation may be stored in each of the compute nodes, and the mapping information may be used to recover from a fault of a compute node or storage node.

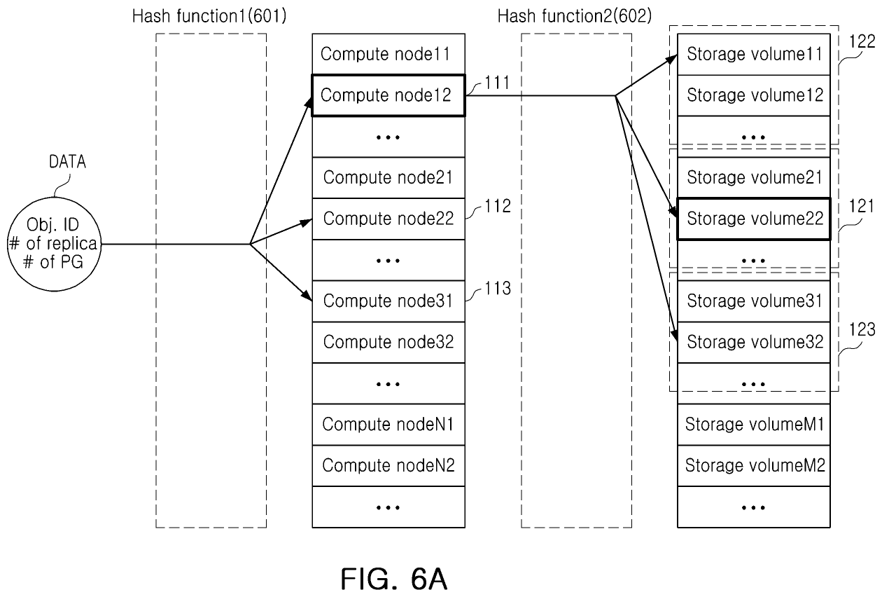

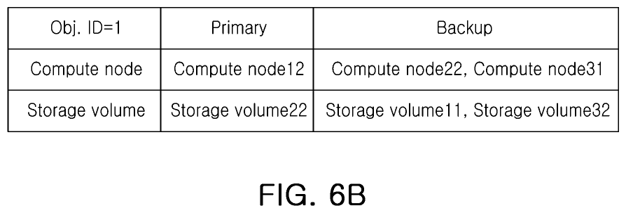

FIGS. 6A and 6B are diagrams illustrating a method of mapping compute nodes and storage nodes.

FIG. 6A is a diagram illustrating a method of determining, based on an identifier of data, compute nodes and storage volumes associated with the data.

When data (DATA) is received from a client, compute nodes may be selected by inputting information associated with the received data into a hash function. For example, an object identifier (Obj. ID) of the data (DATA), the number of replicas (# of replica) to be maintained on a storage system, and a number of a placement group (# of PG) to which an object of the data (DATA) belongs are input into a first hash function 601, identifiers of the same number of compute nodes as the number of replicas may be outputted.

In the example of FIG. 6A, three compute nodes may be selected using the first hash function 601. Among the selected compute nodes (Compute node 12, Compute node 22, and Compute node3l), a compute node (Compute node 12) may be determined as the primary compute node 111, and compute nodes (Compute node 22 and Compute node 31) may be determined as the backup compute nodes 112 and 113.

Once a primary compute node is determined, storage volumes may be selected by inputting an identifier and an object identifier of the primary compute node into a second hash function 602. The storage volumes (Storage volume 11, Storage volume 22, and Storage volume 32) may be selected from different storage nodes. One of the storage nodes may be determined as the primary storage node 121, and the other storage nodes may be determined as the backup storage nodes 122 and 123.

The compute nodes and the storage volumes may be mapped based on the first and second hash functions 601 and 602 for each object identifier. Mapping information representing mapping of the compute nodes and the storage volumes may be stored in the compute nodes and the storage volumes. The mapping information may be referred to when the compute nodes perform a fault recovery or the storage volumes perform a replication operation.

FIG. 6B is a diagram illustrating mapping information of compute nodes and storage volumes. The mapping information may be determined for each object identifier. For example, FIG. 6B illustrates compute nodes and storage volumes associated with data having an object identifier of “1” when three replicas are stored with respect to the data.

The mapping information may include a primary compute node (Compute node 12), backup compute nodes (Compute node 22 and Compute node 31), a primary storage volume (Storage volume 22), and backup storage volumes (Storage volume 11 and Storage volume 32).

When there is no fault in the primary compute node (Compute node 12) and a primary storage node (Storage node2), a request for input/output of the data having the object identifier of “1” may be provided to the primary compute node (Compute node 12), and the primary storage volume (Storage node 22) may be accessed. When a fault is detected in the primary compute node (Compute node 12) or the primary storage node (Storage node2), a backup compute node or a backup storage volume may be searched with reference to mapping information between a compute node and a storage volume, and the backup compute node or the backup storage volume may be used for fault recovery.

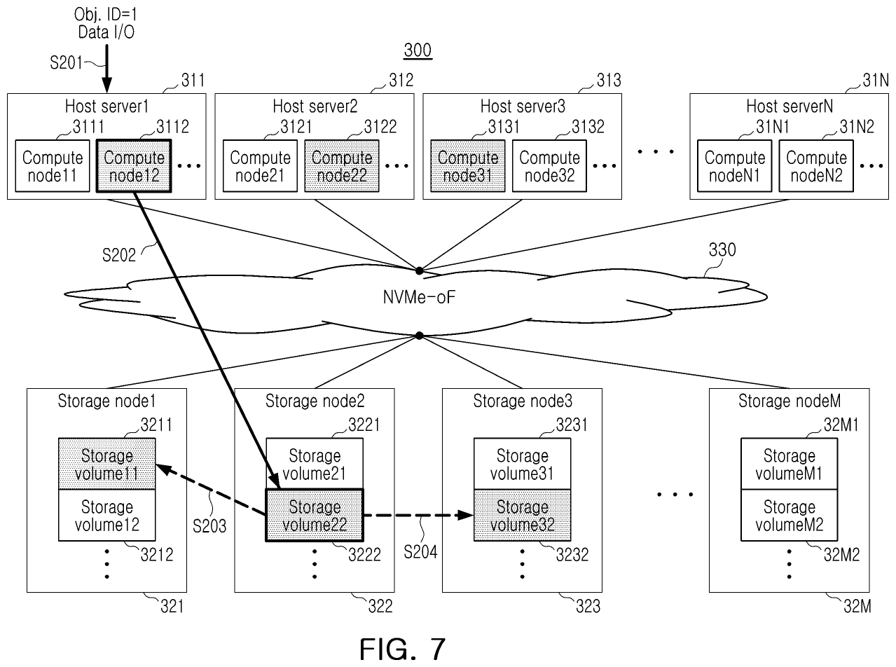

According to an example embodiment, the compute nodes and the storage nodes may be separated from each other, and thus mapping of the compute node and the storage volume may be simply changed, thereby quickly completing the fault recovery. Hereinafter, a data input/output operation and a fault recovery operation of a storage system are described in detail with reference to FIGS. 7 to 9.

FIG. 7 is a diagram illustrating a data input/output operation of a storage system according to an example embodiment.

The storage system 300 illustrated in FIG. 7 may correspond to the storage system 300 described with reference to FIG. 4. In the storage system 300, compute nodes and storage volumes allocated with respect to a first object identifier are illustrated in shade. In addition, a primary compute node 3112 and a primary storage volume 3222 are illustrated by thick lines.

In operation S201, the storage system 300 may receive, from a client, an input/output request for first data having a first object identifier. For example, the client may determine a primary compute node to process the data using the same hash function as the first hash function 601 described with reference to FIG. 6A. In the example of FIG. 6A, the compute node 3112 may be determined as the primary compute node. In addition, the client may control a first host server 311 including the primary compute node 3112 so as to process the input/output request.

In operation S202, the primary compute node 3112 may access, in response to the input/output request, a primary storage volume 322 via a network 330.

The primary compute node 3112 may determine the primary storage volume 3222 and backup storage volumes 3211 and 3232 in which data having the first identifier is stored, using the second hash function 602 described with reference to FIG. 6A. The primary compute node 3112 may store mapping information representing compute nodes and storage volumes associated with the first identifier. In addition, the primary compute node 3112 may provide the mapping information to the primary storage node 322, backup compute nodes 312 and 313, and backup storage nodes 321 and 323.

When the input/output request is a read request, the primary compute node 3112 may acquire data from the primary storage volume 3222. In addition, when the input/output request is a write request, the primary compute node 3112 may provide, to the primary storage node 322, a replication request in conjunction with the first data via the network 330.

The primary storage node 322 may store, in response to the replication request, the first data in the primary storage volume 3222. In addition, in operations S203 and S204, the primary storage node 322 may copy the first data to the backup storage volumes 3211 and 3232. For example, the primary storage node 322 may replicate data by providing the first data and the write request to the backup storage nodes 321 and 323 via the network 330.

According to an example embodiment, the primary storage node 321 may perform a data replication operation, thereby ensuring availability of the storage system 300, and preventing a bottleneck of the primary compute node 3112.

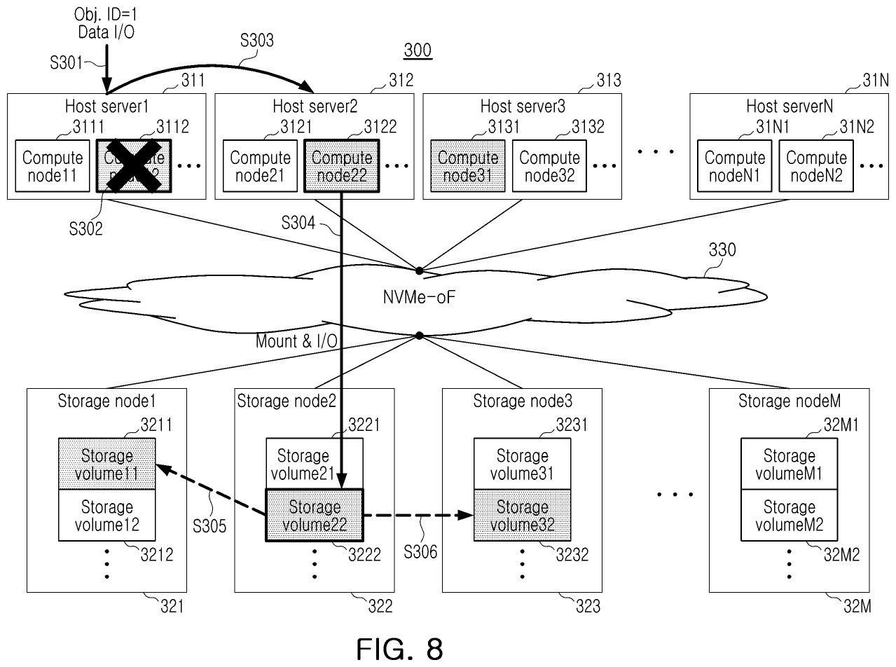

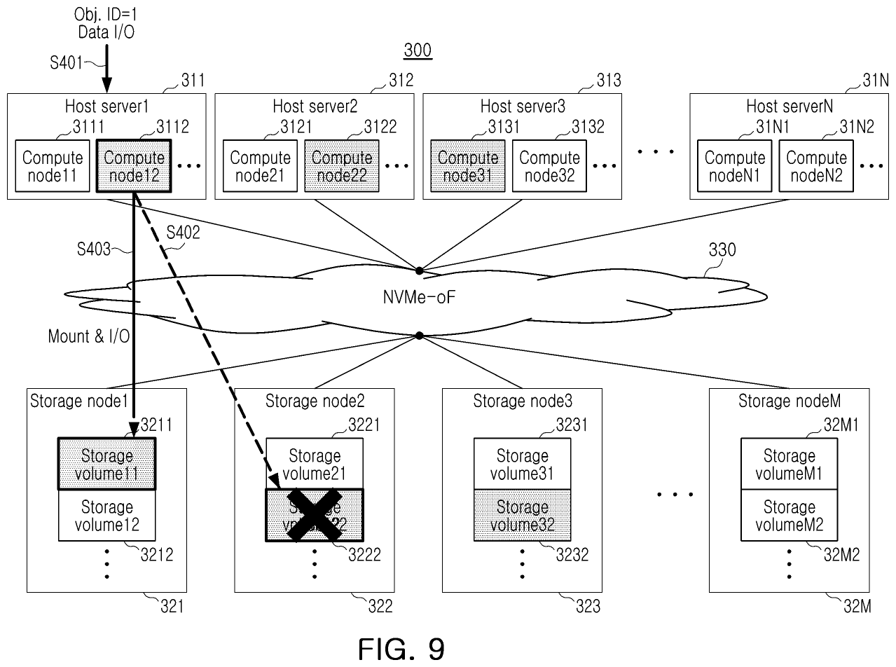

FIGS. 8 and 9 are diagrams illustrating a fault recovery operation of a storage system according to an example embodiment.

FIG. 8 illustrates a fault recovery operation when a fault occurs in the primary compute node 3112. The storage system 300 illustrated in FIG. 8 may correspond to the storage system 300 described with reference to FIG. 4. In the storage system 300, compute nodes and storage nodes associated with a first object identifier are illustrated in shading. In addition, the primary compute node 3112 and the primary storage node 3222 are illustrated by thick lines.

In operation S301, the storage system 300 may receive, from a client, an input/output request for first data having a first object identifier. In a similar manner to that described in relation to operation S201 in FIG. 7, the first host server 311 may receive the input/output request from the client.

In operation S302, the first host server 311 may detect that a fault has occurred in the primary compute node 3112. For example, when the first host server 311 provides a signal so that the primary compute node 3112 processes the input/output request, and there is no acknowledgement for more than a predetermined period of time, it may be determined that a fault has occurred in the primary compute node 3112.

In operation S303, the first host server 311 may change one of the backup compute nodes 3122 and 3131 to a primary compute node, and transmit the input/output request to the changed primary compute node. For example, the first host server 311 may determine the backup compute nodes 3122 and 3131 using the first hash function 601 described with reference to FIG. 6A, and may change the backup compute node 3122 to a primary compute node. In order to provide the input/output request to the changed primary compute node 3122, the first host server 311 may transmit the input/output request to the second host server 312 with reference to the information on the hierarchy structure of the computer nodes described with reference to FIG. 5A.

In operation S304, the primary compute node 3122 may access, in response to the input/output request, the primary storage volume 3222 via the network 330. The primary compute node 3122 may mount the storage volume 3222 so that the primary compute node 3122 accesses the storage volume 3222. Mounting a storage volume may refer to allocating a logical storage space provided by the storage volume to a compute node.

When the input/output request is a write request, the primary compute node 3122 may provide a replication request to the primary storage node 322. The primary storage node 322 may copy the first data to the backup storage volumes 3211 and 3232.

According to an example embodiment, when a fault occurs in a primary compute node, a predetermined backup compute node may mount a primary storage volume, and the backup compute node may process a data input/output request. Accordingly, a storage system may recover from a system fault without performing an operation of moving data stored in a storage volume or the like, thereby improving availability of a storage device.

FIG. 9 illustrates a fault recovery operation when a fault occurs in the primary storage node 322. The storage system 300 illustrated in FIG. 8 may correspond to the storage system 300 described with reference to FIG. 4. In the storage system 300, compute nodes and storage nodes associated with a first object identifier are illustrated in shading. In addition, the primary compute node 3112 and the primary storage node 3222 are illustrated by thick lines.

In operation S401, the storage system 300 may receive, from a client, an input/output request for first data having a first object identifier. In a similar manner to that described in relation to operation S201 in FIG. 7, the first host server 311 may receive the input/output request from the client.

In operation S402, the primary compute node 3112 may detect that a fault has occurred in the primary storage node 322. For example, when the primary compute node 3112 provides an input/output request to the primary storage node 322, and there is no acknowledgement for more than a predetermined period of time, it may be determined that a fault has occurred in the primary storage node 322.

In operation S403, the primary compute node 3112 may change one of the backup storage volumes 3211 and 3232 to a primary storage volume, and access the changed primary storage volume. For example, the primary compute node 3112 may determine the backup storage volumes 3211 and 3232 using the second hash function 602 described with reference to FIG. 6B, and determine the backup storage volume 3211 as the primary storage volume. In addition, the primary compute node 3112 may mount the changed primary storage volume 3211 instead of the existing primary storage volume 3222. In addition, the primary compute node 3112 may access the primary storage volume 3211 via the storage node 321.

According to an example embodiment, when a fault occurs in a primary storage node, a primary compute node may mount a backup storage volume storing a replica of data in advance, and may acquire the data from the backup storage volume, or store the data in the backup storage volume. A storage system may recover from a system fault without performing a procedure such as moving data stored in a storage volume, thereby improving availability of a storage device.

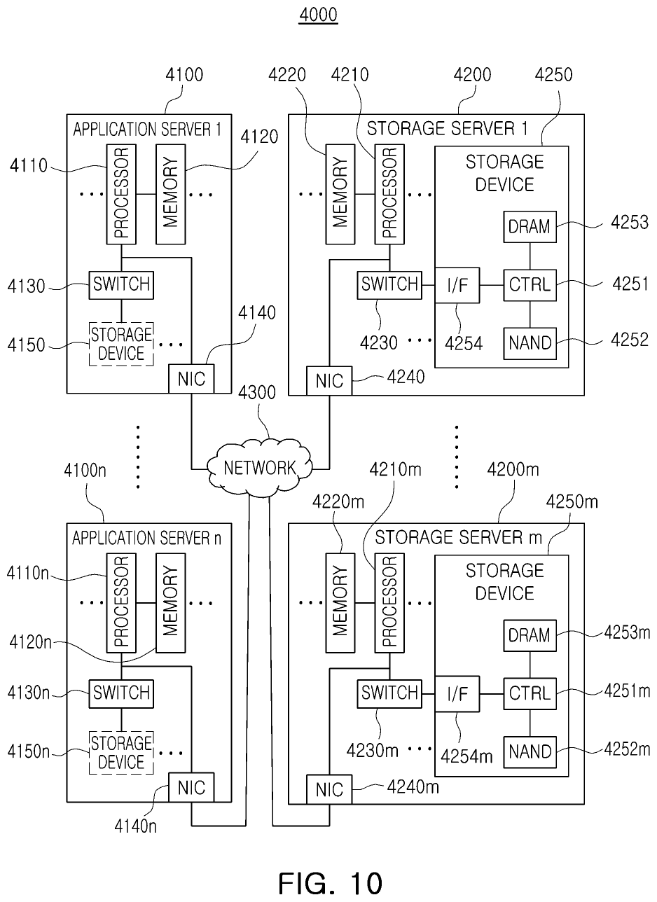

FIG. 10 is a diagram illustrating a data center to which a storage system is applied according to an example embodiment.

Referring to FIG. 10, a data center 4000, which is a facility that collects various types of data and provides a service, may also be referred to as a data storage center. The data center 4000 may be a system for operating a search engine and a database, and may be a computing system used in a business such as a bank or a government institution. The data center 4000 may include application servers 4100 to 4100n and storage servers 4200 to 4200m. The number of application servers 4100 to 4100n and the number of storage servers 4200 to 4200m may be selected in various ways depending on an example embodiment, and the number of application servers 4100 to 4100n and the storage servers 4200 to 4200m may be different from each other.

The application server 4100 or the storage server 4200 may include at least one of processors 4110 and 4210 and memories 4120 and 4220. When the storage server 4200 is described as an example, the processor 4210 may control an overall operation of the storage server 4200, and access the memory 4220 to execute an instruction and/or data loaded into the memory 4220. The memory 4220 may be a double data rate synchronous DRAM (DDR SDRAM), a high bandwidth memory (HBM), a hybrid memory cube (HMC), a dual in-line memory module (DIMM), Optane DIMM, and/or a non-volatile DIMM (NVMDIMM). Depending on an example embodiment, the number of processors 4210 and the number of memories 4220 included in the storage server 4200 may be selected in various ways. In an example embodiment, processor 4210 and memory 4220 may provide a processor-memory pair. In an example embodiment, the number of the processors 4210 and the number of the memories 4220 may be different from each other. The processor 4210 may include a single-core processor or a multi-core processor. The above description of the storage server 4200 may also be similarly applied to the application server 4100. Depending on an example embodiment, the application server 4100 may not include a storage device 4150. The storage server 4200 may include at least one storage device 4250. The number of storage devices 4250 included in the storage server 4200 may be selected in various ways depending on an example embodiment.

The application servers 4100 to 4100n and the storage servers 4200 to 4200m may communicate with each other via a network 4300. The network 4300 may be implemented using Fibre Channel (FC) or Ethernet. In this case, FC may be a medium used for relatively high-speed data transmission, and may use an optical switch providing high performance/high availability. Depending on an access scheme of the network 4300, the storage servers 4200 to 4200m may be provided as a file storage, a block storage, or an object storage.

In an example embodiment, the network 4300 may be a network only for storage, such as a storage area network (SAN). For example, the SAN may be an FC-SAN that uses an FC network and is implemented according to a FC Protocol (FCP). For another example, the SAN may be an IP-SAN that uses a TCP/IP network and is implemented according to an iSCSI (SCSI over TCP/IP or Internet SCSI) protocol. In another example embodiment, the network 4300 may be a generic network, such as a TCP/IP network. For example, the network 4300 may be implemented according to a protocol such as NVMe-oF.

Hereinafter, the application server 4100 and the storage server 4200 are mainly described. A description of the application server 4100 may also be applied to another application server 4100n, and a description of the storage server 4200 may also be applied to another storage server 4200m.

The application server 4100 may store data that is storage-requested by a user or a client in one of the storage servers 4200 to 4200m via the network 4300. In addition, the application server 4100 may acquire data that is read-requested by the user or the client from one of the storage servers 4200 to 4200m via the network 4300. For example, the application server 4100 may be implemented as a web server or database management system (DBMS).

The application server 4100 may access the memory 4120n or the storage device 4150n included in the other application server 4100n via the network 4300, or may access memories 4220 to 4220m or storage devices 4250 to 4250m included in the storage servers 4200 to 4200m via the network 4300. Thus, the application server 4100 may perform various operations on data stored in the application servers 4100 to 4100n and/or the storage servers 4200 to 4200m. For example, the application server 4100 may execute an instruction for moving or copying data between the application servers 4100 to 4100n and/or the storage servers 4200 to 4200m. In this case, the data may be moved from the storage devices 4250 to 4250m of the storage servers 4200 to 4200m to the memories 4120 to 4120n of the application servers 4100 to 4100n via the memories 4220 to 4220m of the storage servers 4200-4200m, or directly to the memories 4120 to 4120n of the application servers 4100 to 4100n. The data moving via the network 4300 may be encrypted data for security or privacy.

When the storage server 4200 is described as an example, an interface 4254 may provide a physical connection between the processor 4210 and a controller 4251, and a physical connection between a network interconnect (NIC) 4240 and the controller 4251. For example, the interface 4254 may be implemented in a direct attached storage (DAS) scheme of directly accessing the storage device 4250 via a dedicated cable. In addition, for example, the interface 4254 may be implemented as an NVM express (NVMe) interface.

The storage server 4200 may further include a switch 4230 and the NIC 4240. The switch 4230 may selectively connect, under the control of the processor 4210, the processor 4210 and the storage device 4250 to each other, or the NIC 4240 and the storage device 4250 to each other.

In an example embodiment, the NIC 4240 may include a network interface card, a network adapter, and the like. The NIC 4240 may be connected to the network 4300 by a wired interface, a wireless interface, a Bluetooth interface, an optical interface, or the like. The NIC 4240 may include an internal memory, a digital signal processor (DSP), a host bus interface, and the like, and may be connected to the processor 4210 and/or the switch 4230 via the host bus interface. The host bus interface may be implemented as one of the above-described examples of the interface 4254. In an example embodiment, the NIC 4240 may be integrated with at least one of the processor 4210, the switch 4230, and the storage device 4250.

In the storage servers 4200 to 4200m or the application servers 4100 to 4100n, a processor may transmit a command to storage devices 4150 to 4150n and 4250 to 4250m or memories 4120 to 4120n and 4220 to 4220m to program or lead data. In this case, the data may be error-corrected data via an error correction code (ECC) engine. The data, which is data bus inversion (DBI) or data masking (DM)-processed data, may include cyclic redundancy code (CRC) information. The data may be encrypted data for security or privacy.

The storage devices 4150 to 4150n and 4250 to 4250m may transmit, in response to a read command received from the processor, a control signal and a command/address signal to NAND flash memory devices 4252 to 4252m. Accordingly, when data is read from the NAND flash memory devices 4252 to 4252m, a read enable (RE) signal may be input as a data output control signal to serve to output the data to a DQ bus. A data strobe (DQS) may be generated using the RE signal. The command/address signal may be latched into a page buffer according to a rising edge or a falling edge of a write enable (WE) signal.

The controller 4251 may control an overall operation of the storage device 4250. In an example embodiment, the controller 4251 may include static random access memory (SRAM). The controller 4251 may write data to the NAND flash 4252 in response to a write command, or may read data from the NAND flash 4252 in response to a read command. For example, the write command and/or the read command may be provided from the processor 4210 in the storage server 4200, a processor 4210m in another storage server 4200m, or processors 4110 and 4110n in application servers 4100 and 4100n. The DRAM 4253 may temporarily store (buffer) data to be written to the NAND flash 4252 or data read from the NAND flash 4252. In addition, the DRAM 4253 may store meta data. Here, the metadata is user data or data generated by the controller 4251 to manage the NAND flash 4252. The storage device 4250 may include a secure element (SE) for security or privacy.

The application servers 4100 and 4100n may include a plurality of compute nodes. In addition, the storage servers 4200 and 4200m may include storage nodes that each provide a plurality of storage volumes. The data center 4000 may distribute and process data having different identifiers in different compute nodes, and may distribute and store the data in different storage volumes. In order to improve availability, the data center 400 may allocate a primary compute node and backup compute nodes to process data having an identifier, and may allocate a primary storage volume and backup storage volumes to store the data. Data that is write-requested by a client may need to be replicated in the backup storage volumes.

According to an example embodiment, a primary compute node may offload a replication operation to a primary storage node providing a primary storage volume. The primary compute node may provide, in response to a write request from a client, a replication request to the primary storage node. The primary storage node may store data in the primary storage volume, and replicate the data in the backup storage volumes.

According to an example embodiment, compute nodes for processing data having an identifier may be allocated from different application servers, and storage volumes for storing the data may be allocated from different storage nodes. According to an example embodiment, compute nodes and storage volumes may be physically distributed, and availability of the data center 4000 may be improved.

According to an example embodiment, when there is a fault in a primary compute node, a primary storage volume may be mounted on a backup compute node. When there is a fault in a primary storage node, a backup storage volume may be mounted on the primary compute node. When there is a fault in the primary compute node or the primary storage node, the data center 4000 may recover from the fault by performing mounting of a compute node and a storage volume. An operation of moving data of the storage volume or the like may be unnecessary to recover from the fault, and thus recovery from the fault may be quickly performed.

While example embodiments have been shown and described above, it will be apparent to those skilled in the art that modifications and variations could be made without departing from the scope of the present inventive concept as defined by the appended claims.

1. A distributed storage system comprising:
a plurality of host servers including a plurality of compute nodes; and
a plurality of storage nodes configured to communicate with the plurality of compute nodes via a network, the plurality of storage nodes comprising a plurality of storage volumes,
wherein the plurality of compute nodes include a primary compute node and backup compute nodes configured to process first data having a first identifier,
the plurality of storage volumes include a primary storage volume and backup storage volumes configured to store the first data,
the primary compute node is configured to provide a replication request for the first data to a primary storage node including the primary storage volume, based on a reception of a write request corresponding to the first data, and
based on the replication request, the primary storage node is configured to store the first data in the primary storage volume, copy the first data to the backup storage volumes, and provide, to the primary compute node, a completion acknowledgement to the replication request.

2. The distributed storage system of claim 1, wherein the primary storage volume and the backup storage volumes are included in different storage nodes among the plurality of storage nodes.

3. The distributed storage system of claim 1, wherein the primary compute node and the backup compute nodes are included in different host servers among the plurality of host servers.

4. The distributed storage system of claim 1, wherein the primary compute node is configured to process a request different from the write request while the primary storage node stores the first data in the primary storage volume, and copies the first data to the backup storage volumes.

5. The distributed storage system of claim 1, wherein
the primary compute node is configured to provide a read request corresponding to the first data to the primary storage node, and
the primary storage node is configured to acquire, based on the read request, the first data from the primary storage volume, and provide the acquired first data to the primary compute node.

6. The distributed storage system of claim 5, wherein
based on a failure to receive an acknowledgement from the primary storage node within a first period of time after the read request for the first data is provided to the primary storage node, the primary compute node is configured to designate a storage node including one of the backup storage volumes as a new primary storage node, and provide a read request to the new primary storage node, and
the new primary storage node is configured to acquire, based on the read request, the data from the backup storage volume in the new primary storage node, and provide the acquired first data to the primary compute node.

7. The distributed storage system of claim 1, wherein
the distributed storage system is configured to distribute and store data in the plurality of storage volumes in units of an object, and
the first identifier is an identifier of the object.

8. The distributed storage system of claim 1, wherein the plurality of storage nodes include a plurality of storage devices, and the plurality of storage nodes are configured to form a storage space provided by the plurality of storage devices into a plurality of logical storage spaces, and provide the plurality of logical storage spaces as the plurality of storage volumes.

9. The distributed storage system of claim 1, wherein the primary storage node is configured to communicate with backup storage nodes including the backup storage volumes via the network, so as to copy the first data.

10. The distributed storage system of claim 1, wherein the plurality of compute nodes and the plurality of storage nodes are configured to communicate according to an NVMe over Fabrics (NVMe-oF) protocol.

11. A distributed storage system comprising:
a plurality of computing domains including a plurality of compute nodes for distributed processing of a plural pieces of data having different identifiers; and
a plurality of storage nodes configured to communicate with the plurality of compute nodes according to an interface protocol, the plurality of storage nodes comprising a plurality of storage volumes for distributed storage of the plural pieces of data having different identifiers,
wherein a primary compute node among the plurality of compute nodes is configured to:
receive a write request for a first piece of data, among the plural pieces of data;
select a primary storage volume and one or more backup storage volumes from different storage nodes among the plurality of storage nodes by performing a hash operation using an identifier of the first piece of data as an input; and
provide a replication request for the first piece of data to a primary storage node including the primary storage volume.

12. The distributed storage system of claim 11, wherein the primary compute node is configured to select backup compute nodes from different computing domains among the plurality of computing domains by performing the hash operation using the identifier of the first piece of data as the input.

13. The distributed storage system of claim 12, wherein the plurality of compute nodes are configured to store mapping information representing a primary compute node, backup compute nodes, a primary storage volume, and backup storage volumes associated with each identifier of the plural pieces of data.

14. The distributed storage system of claim 13, wherein the primary compute node is configured to allocate one of the backup storage volumes with reference to the mapping information, and provide the replication request to the backup storage volumes, based on an occurrence of a fault of the primary storage node being detected after the replication request is provided to the primary storage node.

15. The distributed storage system of claim 11, wherein each of the plurality of computing domains is one of a host server or a server rack.

16. A distributed storage system comprising:
a plurality of host servers including a plurality of compute nodes for distributed processing of a plural pieces of data having different identifiers; and
a plurality of storage nodes configured to communicate with the plurality of compute nodes according to an interface protocol, the plurality of storage nodes comprising a plurality of storage volumes for distributed storage of data pieces having different identifiers,
wherein a primary compute node, among the plurality of compute nodes, is configured to:
receive an access request for a first piece of data, among the plural pieces of data, from a client;
determine, based on an identifier of the first piece of data, a primary storage volume and backup storage volumes storing the first piece of data;
allocate one of the backup storage volumes based on an occurrence of a fault being detected in the primary storage volume; and
process the access request by accessing the allocated storage volume.

17. The distributed storage system of claim 16, further comprising
a first host server including the primary compute node among the plurality of host servers is configured to receive the access request for the first piece of data from the client, and transmit the access request for one of the backup compute nodes based on an occurrence of a fault being detected in the primary compute node,
wherein the one of the backup compute node is configured to allocate the primary storage volume, and process the access request by accessing the allocated storage volume.

18. The distributed storage system of claim 16, wherein the plurality of compute nodes are configured to store mapping information of compute nodes and storage volumes associated with each identifier of data pieces, and refer to the mapping information so as to determine a storage volume to be allocated.

19. The distributed storage system of claim 16, wherein the primary compute node and the backup compute nodes are included in different host servers among the plurality of host servers.

20. The distributed storage system of claim 16, wherein the primary storage volume and the backup storage volumes are included in different storage nodes among the plurality of storage nodes.

21-25. (canceled)
